(19) United States
(12) Patent Application Publication
(10) Pub. No.: US 2005/0100650 A1
(43) Pub. Date: May 12, 2005

(54) Granules and powders for instant drinks which are prepared using an extrusion cooking method

(76) Inventors: Jean Lepagnol, Chaudon (FR); Laura Barsotti, Amiens (FR); Arnaud Vannier-Moreau, Paris (FR); Eric Prudhomme, Amiens (FR)

Correspondence Address: YOUNG & THOMPSON, 745 SOUTH 23RD STREET, 2ND FLOOR, ARLINGTON, VA, 22202, US

(21) Appl. No.: 10/491,477

(22) PCT Filed: Oct. 3, 2002
(86) PCT No.: PCT/FR02/03379

(30) Foreign Application Priority Data
Oct. 4, 2001 (FR) 01/12793

(51) Int. Cl. A23K 1/00

(52) U.S. Cl. 426/615

(57) ABSTRACT

Preparation by means of extrusion cooking of granules or powders from nuts and/or oleaginous fruits and/or oil seeds, which are optionally and partially defatted and/or dried in toto, the granules and powders being intended in particular for instant drinks. More specifically, the extrusion cooking method which is used in order to prepare the highly-nutritional granules or powders allows for the introduction of a high weight percentage (>/=40%) of the vegetable raw materials and for the concentration of the active ingredients and natural nutriments thereof.

The subject of the present invention is the preparation, by extrusion cooking, of granules or powders, in particular for instant drinks, from shell fruits and/or oleaginous fruits and/or oilseeds, optionally and partially freed from oil and/or dried in toto. More particularly, the extrusion cooking method used for preparing the granules or powders with a high nutritional value according to the invention makes it possible to introduce these plant raw materials at a high percentage by weight (≧40%) and to concentrate therein their active ingredients and their natural nutrients.

It is known that shell fruits, and in particular oleaginous shell fruits such as almond, walnut or hazelnut, possess advantageous and supplementary nutritional properties. There may be mentioned for example the mineral supply by almond, the supply of antioxidant substances by hazelnut, the supply of high-energy vitamins by chestnut, the supply of essential fatty acids by walnut.

However, the nutritional supply by these fruits remains limited, during their consumption in the native state, by their richness in hypercaloric lipids or by their richness in water which dilutes the concentration of nutrients and in particular of proteins, vitamins or minerals.

Moreover, it has now been established that an increasingly high population, in particular in children and elderly persons, has digestive disorders and/or allergies during the consumption of animal milk and of dairy products through intolerance to lactose or to milk proteins. Furthermore, these products contain a high percentage of saturated fats which are harmful for subjects susceptible to cardiovascular diseases.

Accordingly, vegetable drinks which are pleasant for ordinary consumption, more easily digested, non allergenic, free from saturated fatty acids, without lactose or cholesterol have been proposed as a substitute for animal milk because they possess nutritional value or even an essential characteristic for part of the population.

In this context, various methods of preparing finished products from shell fruits have been proposed.

Thus, “milk” preparations based on almonds which have been partially freed from oil and which can be directly consumed have been described. Their method of manufacture consists in dispersing a small quantity of fruit powder in a solution supplemented with hydrocolloids or not. This solution or this suspension is then subjected to a heating operation for solubilization (EP 0-776-165), and/or grinding, centrifugal clarification and UHT sterilization operations (U.S. Pat. No. 5,656,321). Unfortunately, such a method makes it possible to obtain only 5.5% of dry matter in the final preparation and limits the nutritional value thereof. This type of method does not make it possible to obtain a preparation which is useful as an animal milk substitute.

Another method consists in manufacturing an instant powder from a fruit paste obtained by mixing and homogenizing ground fruits, water and various ingredients such as sugars or oligopolysaccharides (ES 2 150 878). This stock paste is then spray-dried on an instantization support including maltodextrin. Such a method requires numerous manufacturing steps, in particular in the hot state by UHT treatment, and a high percentage by weight (58 to 60%) of maltodextrin, which makes it possible to obtain only 30 to 35% of fruits or of fruit extract by weight in the final preparation (product obtained directly from spray-drying excluding any subsequent supplementation) and which consequently limits the nutritional value of the product. Nevertheless these instant drinks powders have been proposed as an animal milk substitute.

Moreover, shell fruits or plant substances obtained from oleaginous plants have been widely used for obtaining finished products having an attractive visual or taste characteristic.

There may be mentioned, by way of representative example, the use of cocoa beans for:
the manufacture, by simple mixing of ingredients, of a non instant powder for suspension (DE 296 08 942),
the preparation of a malted drink containing 5% of cocoa and prepared by vacuum-drying a liquid mixture (EP 1 068 807).

Among the methods of manufacture used for the preparation of various finished products with a taste profile and which can be directly consumed, the extrusion cooking method has been proposed.

For representative examples, there may be mentioned:
the continuous manufacture of almond paste from blanched almonds and by the use of high-temperature cooking in order to allow the development of Maillard biochemical reactions and thus the development of flavor substances (EP 0 247 926 B1),
the manufacture of granules by compressing mixtures of aqueous fruits and of oleaginous fruits ground beforehand (U.S. Pat. No. 4,744,995),
the confectionery manufacture of chocolates having a solid or semisolid consistency (EP 0 820 701),
the manufacture of dehydrated food products such as soups, seasonings, sauces, meat or vegetable extracts, from naturally hydrated ingredients or ingredients supplemented with water so as to then make them more hydrophilic and therefore more soluble during normal use (U.S. Pat. No. 4,060,645),
the manufacture of nutritive malted drinks with a cocoa taste (EP 0 920 814),
the manufacture of cocoa-based chips obtained in particular after high-temperature drying (U.S. Pat. No. 3,997,680).

No nutritional value, linked to the use of the extrusion cooking method and/or to the use of shell fruits or of plant substances obtained from oleaginous plants, is indicated for the preparations thus obtained.

In the light of the preparations currently proposed as animal milk substitute and described in the prior art, it seems necessary to develop preparations having improved nutritional properties, in particular by virtue of natural nutrients whose bioavailability is higher than that of synthetic nutrients (for example: BURTON G. W. et al., Am. J. Clin. Nutrition, 1998, 67, 669-684). The authors of the present invention have developed a novel method which allows the preparation of granules or powders, in particular for instant drinks, in which the nutritional and dietary supplies are increased by virtue of the use of an extrusion cooking method which allows the introduction of a high percentage of plant substances, while preserving the ease of use of such preparations as soluble or dispersible granules or powders. Indeed, the prior art methods, such as spray-drying, do not make it possible to treat initial preparations containing a high percentage by weight of plant, in particular oleaginous, substances while producing powders easily soluble or dispersible in an aqueous medium.

Furthermore, the use of the extrusion cooking method according to the invention is a solution which is novel, appropriate and advantageous from the nutritional point of view by the fact that only a single manufacturing step in the hot state is necessary, and that the very short period of exposure of the original plant substance(s) to a high temperature makes it possible, unlike the prior art products, to preserve all or in a large part, or even to concentrate, their natural nutritional supply.

### Definitions

According to the invention, the expression “plant substances” is understood to mean substances chosen from the group consisting of shell fruits, oleaginous fruits and oilseeds.

The term “shell fruits” defines dried fruits or almonds surrounded by ligneous shells or hard outer coats, which are themselves generally covered with a thick, fleshy and/or fibrous outer coat. Conventionally, this group comprises dessert or table shell fruits. They may be “oleaginous shell fruits” (almonds, hazelnuts, pistachio nuts and various types of nut—walnut, Brazil nut, cashew nut, pecan nut, Macademia nut) or “non oleaginous shell fruits” (chestnuts).

The expression “oleaginous” fruits is understood to mean fruits (with the exception of shell fruits) produced by annual or perennial plants which are cultivated and exploited for their oil-rich fruits such as olive and avocado.

The expression “oilseeds” is understood to mean oil-rich seeds. They may be seeds obtained from oleaginous plants, that is to say annual or perennial plants cultivated and exploited for their oil-rich seeds, such as sunflower seed, castor seed, linseed; or seeds not obtained from oleaginous plants, such as pine seed, carob seed.

In the context of the present invention, the plant substances are more particularly chosen from the group consisting of almonds, hazelnuts, walnuts, chestnuts, Amazonia nuts, Macademia nuts, avocados and carob seeds.

The plant substances used for the preparation of the granules or powder according to the invention are therefore products rich in oil and/or fatty substances for which the processing conditions by the prior art methods are scarcely compatible with their introduction at a high percentage by weight into the initial mixture and maintaining their original nutritional properties.

The expression granules or powders of “nutritional value” is understood to mean granules or powders with a high content of nutrients such as essential amino acids and unsaturated fatty acids, of vitamins, minerals and trace elements, for example vitamins A, C, E, group B vitamins, or minerals and trace elements such as calcium, magnesium, manganese, copper, phosphorus, iron, zinc, cobalt, selenium, chromium, fluorine, molybdenum. More particularly, the products of nutritional value prepared by extrusion cooking according to the invention are characterized by an increased content of nutrients, vitamins, minerals and trace elements of plant origin compared with products prepared by a conventional spray-drying method. The term nutritional therefore relates to the natural supply of metabolic elements essential for the functions of the body, by contrast to the term “nutritive” which generally denotes a nourishing supply in terms of calories.

In the context of the present invention, the expression “additives” denotes ingredients added individually or in combination, preferably to the plant substances before extrusion, but also to the extruded product. They may be:
carbohydrates, lipids or proteins represented, for example, by fruit or vegetable or seed extracts (other than the plant substances defined above), starches, gums, dextrins, alginates, gelatines, hydrolysates or autolysates of proteins, fats;
nutritional substances such as vitamins, minerals, trace elements or essential fatty acids, spices, flavorings, colorings or salts.

The characteristics of the extrusion cooking method according to the invention indeed make it possible to introduce, as additives, nutrients reputed to be heat-sensitive into the initial mixture before extrusion.

The expression “flavoring mixture” is understood to mean a mixture comprising for example an aqueous-alcoholic plant extract, a cereal syrup combined with one or more fruit flavorings such as almond, hazelnut, chestnut, vanilla or any other flavoring used in the food industry.

### DESCRIPTION OF THE INVENTION

The subject of the present invention is therefore a method for producing, preferably continuously, granules or powders of nutritional value, in particular for instant drinks, from plant substances, by an extrusion cooking treatment in which the specific mechanical energy (SME) is between 25 and 100 Wh/kg and with a sheath temperature of between 60° C. and 160° C.

The method according to the present invention comprises in particular the carrying out of the following steps:
a) introduction of one or more plant substances, optionally in the form of a mixture with one or more additives, into the cooker-extruder;
b) grinding and blending the mixture with cooking at a sheath temperature of between 60 and 160° C.;
c) compression of the product obtained;
d) extrusion of the product by passing through a die placed at the outlet of the cooker-extruder;
e) dehydration by sudden expansion of the product in the open air;
f) cooling with ventilated air;
g) optionally grinding;
h) optionally addition of additive(s).

According to a preferred embodiment of the invention, the plant substance(s) may be used in toto and preferably at a total percentage by weight greater than 40% in the initial preparation, preferably at a total percentage by weight greater than 50%, preferably still at a total percentage by weight greater than 60%. Advantageously, the plant substance(s) are used after drying, with a residual water level of between 2 and 20%. Preferably still, the plant substance(s) are used after freeing from oil, advantageously in the cold state, in the form of a cake in which the residual lipid level is between 3 and 40% so as to obtain, according to the plant material used, an extruded product which is more or less oily in order to be suitable for grinding. Advantageously, said plant substances, optionally dried and/or freed from oil, are in powdered form.

The possible drying or oil removal steps may be carried out according to conventional methods known to a person skilled in the art, such as hot air drying, screw pressing, in particular in the cold state or hexane extraction with distillation drying.

The additives may be incorporated in powdered and/or solution form. The whole of the mixture should however retain a thermoplastic character in order to allow an extrusion cooking method at a temperature compatible with the nutritional value of the finished product (La cuisson-extrusion. P. COLONNA and G. DELLA VALLE—Collection Technique et Documentation. Ed. Lavoisier, 1994, 545 p.).

According to one variant of the present invention, a portion of the additives is added in the form of a liquid flavoring mixture to the plant substances, and optional additives, before extrusion, separately but rapidly and successively. According to yet another variant, a liquid flavoring mixture is added after extrusion to the plant substances and optional extruded additives, preferably in the form of a pulverulent mixture. Therefore falling within the scope of the invention are a method in which the plant substance(s) are extruded in the form of a pulverulent mixture with addition of a liquid flavoring mixture after extrusion and a method in which the plant substance(s) are extruded in the form of a pulverulent mixture with addition of a liquid flavoring mixture before extrusion.

The possibility of flavoring the initial mixture before extrusion is indeed an additional advantage of the method. Such a flavoring has the effect of preserving or increasing the taste appeal of the original plant substances. The method according to the invention may moreover include a flavoring, or more generally additive(s) adding, step once the product has been extruded.

Advantageously, the introduction, before extrusion, of extrudable ingredients such as maltodextrin into the initial mixture, at a low percentage by weight (30% or less), makes it possible to optimize the content of plant substance (40% by weight or more) while preserving the ease of use of the soluble granule or powder preparations thus produced.

The representative parameters of the method which is the subject of the present invention are the specific mechanical energy and the temperature in the cooker-extruder. The document, which is incorporated herein by reference, describing the specific mechanical energy is: MEUSER F. et VAN LENGERICH B. Systems analytical model for the extrusion of starches. In: Thermal processing and quality of foods, ZEUTHEN P., CHEFTEL J. C., JUL M., LENIGER H., LINKO P., VARELA G., VOS G., Eds. Elsevier Applied Sci. Publ., London, pp. 175-179.

The SME of the method of the present invention is between 25 and 100 Wh/kg, and preferably between 35 and 90 Wh/kg.

The method and the applications inherent to the present invention may be carried out in any type of cooker-extruder, preferably in a twin-screw extruder. There may be mentioned, by way of examples, the corotating and copenetrating twin-screw BC 45 model, BC 21, BC 72 and BC 82 from the company Clextral, the twin-screw extruder ZSK 40 from the company Werner & Pfleiderer GmbH, the extruder X-5 from Wenger or MPF-50/25 from APV Baker.

Conventionally, the screws of the cooker-extruder are driven in rotation round their axes by a motor and a reducing gear inside an oblong chamber forming a sheath surrounding them.

According to the products considered, the screws may comprise positive action sections with different pitches and/or sections with negative pitches or counter-threads, and/or sections consisting of blending disks. In general, the screws consist of a succession of these different types of sections, forming zones for treatment of raw materials, and may be adapted in an innovative and specific manner for each mixture of raw materials in order to obtain a finished product which is appropriate from the point of view of texture, organoleptic character and nutritional value.

The screw speeds vary specifically and preferably between 110 and 450 rpm (rotations per minute) and advantageously between 160 and 400 rpm. To this effect, the throughput of pulverulent material introduced upstream of the cooker-extruder is between 80 and 250 kg/h and advantageously between 130 and 220 kg/h. The rate of feeding with “flavoring mixture” is preferably between 10 and 20 l/h, advantageously between 13 and 17 l/h.

The sheath of the cooker-extruder is equipped with several modules (3 to 7 modules having an individual length of 200 mm in the case of Clextral BC 45) for an overall sheath length of between 600 and 1400 mm. These modules are either leaktight, or perforated with one or more orifices allowing the introduction of raw materials into the cooker-extruder and the instant degassing of the product used.

The sheath temperature may be regulated by a heat transfer fluid, by band heaters or induction coils or alternatively by a combined system, in particular heating by thermal induction and cooling by circulation of cold water.

The temperature may vary in the various modules of the sheath. Advantageously, the first part of the sheath (part for feeding with reagents, often exemplified by the first module perforated with orifices) is cooled to a temperature between 15 and 50° C. The temperature of the other components of the sheath is differentially regulated between 60 and 160° C., preferably between 70 and 150° C.

At the end of the sheath is a die assembly, namely a front plate and a generally cylindrical die. Advantageously, a system of rotating knives is placed on the external face of the die in order to section the extruded product into granules having a length generally of between 5 and 15 mm and having an appropriate texture so as to allow optional grinding thereof into a powder which is soluble or dispersible in an aqueous medium in the cold state and/or in the hot state and with a particle size generally of between 50 and 500 μm, preferably between 200 and 300 μm. According to a first variant, the extruded string is free to expand completely before being sectioned into regular sections. According to a second variant, the extruded string is sectioned before its complete expansion by means of rotating blades placed just after the extrusion die. A method in which the extruded product is sectioned before its expansion and a method in which the extruded product is sectioned after its expansion therefore also fall within the scope of the present invention. The measurements of particle size may be carried out by the laser granulometry technique, using a MALVERN granulometer, marketed by the company Malvern Instruments S.A.

The powder may be obtained by conventional grinding means such as grinding in mills of the roll mill type for powders of average particle size of the 100 mesh type, or pin mills for powders of finer particle size, of the 175 or 200 mesh type.

The present invention also relates to a product of nutritional value, in the form of granules or powders, manufactured from plant substances by an extrusion cooking treatment. More particularly, the product which is the subject of the present invention can be obtained by an extrusion cooking method as described above.

The product according to the invention may be manufactured from one or more plant substance(s) chosen from shell fruits, oleaginous fruits and oilseeds. Preferably, the plant substance(s) are chosen from the group consisting of chestnut, almond, hazelnut, walnut, Amazonia nut, Macademia nut, avocado and carob seeds.

According to a preferred embodiment of the invention, the plant substance(s) are present at a total percentage by weight greater than 40%, preferably greater than 50% by weight, preferably still greater than 60% by weight.

The product according to the present invention may be provided in the form of an instant drink powder which is soluble or dispersible in an aqueous medium, in the cold state or in the hot state, with a particle size generally of between 50 and 500 μm, preferably between 200 and 300 μm. According to another aspect of the invention, the product is provided in the form of granules having a length generally of between 5 and 15 mm, whose texture is advantageously appropriate for allowing their optional grinding into a powder according to the invention or their sectioning as so-called breakfast chips or petals.

By virtue of the possibility of introducing a high percentage of vegetable substances, the products obtained from the method of the present invention differ very widely from those of the prior art as regards their nutritional qualities.

Indeed, in the absence of final supplementation with additives of nutritional value, the products obtained from the method according to the invention are of greater nutritional value than the instant powders of the prior art, in particular those obtained by the spray-drying method.

The nutritional supplies cover, in the first place, the supplies in terms of nutrients (proteins, lipids). By way of example, 100 g of an instant powder based on almonds according to the invention supplies 22.9 g of proteins and 19 g of lipids instead of 12.5 g of proteins and 13.5 g of lipids as supplied by a product prepared by the spray-drying method. The resulting supplies of essential amino acids and unsaturated fatty acids are thus in conformity with the recommended supplies for the overall energy value of the product. The nutritional supplies also and advantageously cover the supplies of vitamin compounds, of minerals and of trace elements, with energizing and/or mineralizing and/or protective metabolic properties. By way of examples, there may be mentioned vitamins such as the group B vitamins, vitamins A, C, E or minerals and trace elements such as calcium, magnesium, manganese, copper, phosphorus, iron, zinc, cobalt, selenium, chromium, fluorine, molybdenum.

The products based on shell fruits of the present invention thus possess, according to the nutrients considered and specific to the original fruit, nutritional supplies greater than 40 to 720% relative to those of the instant powders produced by the sequential refining and spray-drying method. By way of example:
an instant powder based on hazelnuts obtained from the present invention provides about 50% of supplementary vitamin E and 3 to 4 times more calcium, magnesium, copper and manganese,
an instant powder based on chestnuts obtained from the present invention provides about 6 to 7 times more vitamin C,
an instant powder based on almonds obtained from the present invention provides about 2 to 4 times more vitamin B9, iron and zinc.

Furthermore, they make it possible to supply the vitamin and mineral nutrients to correspond to 36 up to 270% of the recommended daily intakes (RDI) and the recommended nutrient intakes (RNI) in children or adults as defined by the FAO/WHO “Report on recommended nutrient intakes—Sep. 21-30th, 1998” and in the report “31st series” by the scientific committee on human food of the European Commission and within the safety limits defined on Sep. 12, 1995 by the High Council for Public Hygiene in France.

In the context of the present invention, it has been possible to produce numerous preparations by varying the formula of the mixture(s) before extrusion cooking in order to obtain extruded products with optimum nutritional characteristics and optionally capable of being ground in order to obtain appropriate aqueous dispersibility.

For example, a simple mixture of plant substances and additives of the carbohydrate type, in particular of the saccharide type, may be subjected to the extrusion cooking method and the extruded product is coated or mixed, after grinding, with a flavoring solution composed of syrup, sugar and flavoring. Advantageously, from the nutritional point of view, the product is obtained from the treatment of a flavoring mixture introduced before extrusion with the mixture of plant substances and additives, preferably pulverulent, so as in particular to obtain a homogeneous distribution and supply of the components and thus a homogeneous and synergistic bioavailability of the nutrients and of the nutritional components.

The improved nutritional qualities of the products according to the present invention do not however exclude the possibility of supplementing said products obtained from the method with components of nutritional value such as vitamins, minerals, trace elements, amino acids or fatty acids.

The following non limiting examples are respresentative of the present invention.

### EXAMPLES

The examples described below were carried out using the following items of equipment: Lodige mixer, twin-screw BC 45 extruder (with co-rotating and co-penetrating screws) at 66 kW (Clextral), rotating blades, vibrating and cooled fluidized bed.

Unless otherwise stated, the percentages are expressed by weight.

### Example 1

### Almond-Based Instant Drink Powder

An almond cake obtained by pressing and containing 27 to 31% of residual lipids is mixed with other pulverulent materials in the following proportions: almond cake 65.9%, cereal maltodextrin 27.5%, cane sugar 3.3%, gum acacia and xanthan gum 3.3%.

Moreover, a flavoring mixture containing 19% of water is introduced at the top of the cooker-extruder and according to the following formula: cereal syrup 89%, flavorings 11%.

For this formula, the extrusion cooking conditions are the following:

| | |
|---|---|
| Characteristics of the screw | Length 1000 mm |
| profile | 1 negative pitch zone, |
| | 2 blending zones |
| Sheath temperatures | Module 2: 85° C. |
| | Module 3: 135° C. |
| | Module 4: 145° C. |
| | Module 5: 82° C. |
| Die outlet temperature | 86° C. |
| Screw speed | 250 rpm |
| Throughput flavoring mixture | 15.75 l/h |
| Throughput pulverulent | 159.25 kg/h |
| mixture | |
| Specific Mechanical Energy | 47.1 Wh/kg |

Under these conditions, the present invention makes it possible to supply and preserve largely the nutritional components of the original fruit, in particular in terms of nutrients with mineralizing and protective properties as indicated in the following table.

| | | | Example 1 | |
|---|---|---|---|---|
| | Native | Finished | Almond | |
| | almond | product | equivalent | % RDI |
| | (mg/100 g) | (mg/100 g) | (%) | Children |
| Vitamin B9 | 0.06 | 0.04 | 69 | 100 |
| Vitamin E | 23.6 | 5.5 | 23 | 110 |
| Calcium | 266 | 208 | 78 | 42 |
| Magnesium | 274 | 80 | 29 | 100 |
| Iron | 3.1 | 2.5 | 81 | 36 |

By way of comparison, these nutritional values of the product of the invention are 71 to 174% higher relative to the equivalent product currently marketed and obtained by the spray-drying method from the same original fruits.

### Example 2

### Hazelnut-Based Instant Drink Powder

A hazelnut cake obtained by pressing and containing 15 to 17% of residual lipids is mixed with other pulverulent materials in the following proportions: hazelnut cake 65.6%, cereal maltodextrin 27.8%, sucrose 3.3%, gum acacia 3.3%.

Moreover, a flavoring mixture containing 20% of water is introduced at the top of the cooker-extruder and according to the following formula: cereal syrup 89%, flavorings 11%.

For this formula, the extrusion cooking conditions are the following:

| | |
|---|---|
| Characteristics of the screw | Length 1000 mm |
| profile | 1 negative pitch zone, |
| | 2 blending zones |
| Sheath temperatures | Module 2: 70° C. |
| | Module 3: 140° C. |
| | Module 4: 140° C. |
| | Module 5: 73° C. |
| Die outlet temperature | 107° C. |
| Screw speed | 247 rpm |
| Throughput flavoring mixture | 13.6 l/h |
| Throughput pulverulent | 146.4 kg/h |
| mixture | |
| Specific Mechanical Energy | 60 Wh/kg |

Under these conditions, the present invention makes it possible to supply and preserve largely the nutritional components of the original fruit, in particular in terms of nutrients with antioxidant protective properties as indicated in the following table.

| | | | Example 2 | |
|---|---|---|---|---|
| | Native | Finished | Hazelnut | |
| | hazelnut | product | equivalent | % RDI |
| | (mg/100 g) | (mg/100 g) | (%) | Adults |
| Vitamin E | 42.7 | 14.2 | 33.3 | 118 |
| Copper | 1.8 | 2.2 | 122.2 | 108 |
| Manganese | 8.4 | 2.5 | 29.8 | 83 |
| Zinc | 5.2 | 6 | 115.4 | 50 |
| Phosphorus | 189 | 524 | 277.2 | 70 |

By way of comparison, these nutritional values of the product of the invention are 50 to 198% higher relative to the equivalent product currently marketed and obtained by the spray-drying method from the same original fruits.

### Example 3

### Chestnut-Based Instant Drink Powder

Ground chestnuts, optionally dried beforehand, are mixed with other pulverulent materials in the following proportions: chestnuts 66.7%, cereal maltodextrin 28.3%, sucrose 2.8%, hydrocolloids 2.2%.

Moreover, a flavoring mixture containing 17% of water is introduced at the top of the cooker-extruder and according to the following formula: cereal syrup 80%, flavorings 20%.

For this formula, the extrusion cooking conditions are the following:

| | |
|---|---|
| Characteristics of the screw | Length 1000 mm |
| profile | 1 negative pitch zone, |
| | 1 blending zone |
| Sheath temperatures | Module 2: 83° C. |
| | Module 3: 110° C. |
| | Module 4: 122° C. |
| | Module 5: 115° C. |
| Die outlet temperature | 122° C. |
| Screw speed | 375 rpm |
| Throughput flavoring mixture | 15 l/h |
| Throughput pulverulent | 135 kg/h |
| mixture | |
| Specific Mechanical Energy | 90 Wh/kg |

Under these conditions, the present invention makes it possible to supply and preserve largely the nutritional components of the original fruit, in particular in terms of nutrients with energizing properties as indicated in the following table.

| | | | Example 3 | |
|---|---|---|---|---|
| | Native | Finished | Chestnut | |
| | chestnut | product | equivalent | % RDI |
| | (mg/100 g) | (mg/100 g) | (%) | Children |
| Vitamin B1 | 0.34 | 0.25 | 73.5 | 36 |
| Vitamin C | 115 | 96 | 83.5 | 274 |
| Magnesium | 81 | 69 | 85.2 | 86 |

By way of comparison, these nutritional values of the product of the invention are 50 to 620% higher relative to the equivalent product currently marketed and obtained by the spray-drying method from the same original fruits.

### Example 4

### Almond- and Quinoa-Based Instant Drink Granule and Powder

An almond cake obtained by pressing and containing 27 to 31% of residual lipids is mixed with other pulverulent materials in the following proportions: almond cake 50.1%, ground quinoa seed 6.0%, cereal meals 27.4%, cane sugar 8.0%, fructose 4.0%, wheat bran 4.0%, salt 0.5%.

Moreover, a flavoring mixture containing 20.5% of water is introduced at the top of the cooker-extruder and according to the following formula: cereal syrup 88.2%, flavorings 11.8%.

For this formula, the extrusion cooking conditions are the following:

| | |
|---|---|
| Characteristics of the screw | Length 1000 mm |
| profile | 1 negative pitch zone, |
| | 1 blending zone |
| Sheath temperatures | Module 2: 80° C. |
| | Module 3: 150° C. |
| | Module 4: 135° C. |
| | Module 5: 70° C. |
| Die outlet temperature | 89° C. |
| Screw speed | 250 rpm |
| Throughput flavoring mixture | 15 l/h |
| Throughput pulverulent | 200 kg/h |
| mixture | |
| Specific Mechanical Energy | 61.9 Wh/kg |

Under these conditions, the present invention makes it possible to preserve largely the nutritional supplies of the original plant substances and in particular in terms of heat-sensitive nutrients, with energizing properties such as phosphorus (62% of the content of the original fruits), vitamin B1 (80% of the content of the original fruits) and vitamin C (75% of the content of the original fruits).

1. A product of nutritional value, in the form of granules or powders, manufactured from plant substances by an extrusion cooking treatment in which the plant substance(s) are present at a total percentage by weight greater than 40%.

2. The product as claimed in claim 1, in which a plant substance is chosen from the group consisting of oleaginous shell fruits.

3. The product as claimed in claim 1, in which a plant substance is chosen from the group consisting of non oleaginous shell fruits.

4. The product as claimed in claim 1, in which a plant substance is chosen from the group consisting of oleaginous fruits.

5. The product as claimed in claim 1, in which a plant substance is chosen from the group consisting of oilseeds obtained or otherwise from oleaginous plants.

6. The product as claimed in claim 1, in which the plant substance(s) are chosen from the group consisting of chestnut, almond, hazelnut, walnut, Amazonia nut, Macademia nut, avocado and carob seeds.

7. The product as claimed in claim 1, in the form of a powder which is soluble or dispersible in aqueous medium for an instant drink.

8. The product as claimed in claim 1, in which the plant substance(s) are present at a total percentage by weight greater than 50%.

9. The product as claimed in claim 1, in which the plant substance(s) are present at a total percentage by weight greater than 60%.

10. A method for producing a product as claimed in claim 1, by an extrusion cooking treatment whose specific mechanical energy is between 25 and 100 Wh/kg and with a sheath temperature of between 60° C. and 160° C.

11. The method as claimed in claim 10, in which the plant substance(s) are used in toto at a total percentage by weight greater than 40% in the initial preparation.

12. The method as claimed in claim 10, in which the plant substance(s) are used after drying and whose residual water content is between 2 and 20%.

13. The method as claimed in claim 10, in which the plant substance(s) are used after freeing from oil in the form of a cake whose residual lipid level is between 3 and 40%.

14. The method as claimed in claim 11, in which the plant substance(s) are used after drying and whose residual water content is between 2 and 20%.

15. The method as claimed in claim 11, in which the plant substance(s) are used after freeing from oil in the form of a cake whose residual lipid level is between 3 and 40%.

16. The method as claimed in claim 12, in which the plant substance(s) are used after freeing from oil in the form of a cake whose residual lipid level is between 3 and 40%.
